(19) United States
(12) Patent Application Publication
(10) Pub. No.: US 2006/0226040 A1
(43) Pub. Date: Oct. 12, 2006

(54) Scratch resistant skin for a laptop computer

(76) Inventor: Corrine Medina, Huntington Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/104,809

(22) Filed: Apr. 12, 2005

(51) Int. Cl. B65D 85/00; B65D 65/02; G06F 1/16

(52) U.S. Cl. 206/320; 361/683; 150/165

(57) ABSTRACT

A laptop computer has an exhaust port on a rear panel. A thin film skin is engaged with the computer placing a generally planar top panel and a generally planar bottom panel on the computers top and bottom exposed faces. The panels are joined by an elastic hinge around the rear panel. Comer grippers are engaged with the computer's corners to enable the skin to fit tightly on the computer. The hinge has such an elastic property, that, with the comer grippers engaged with the computer, the hinge lays in a stretched condition proximate the rear panel with the computer open or closed thereby preventing bulging of the hinge or thin film panels.

### RELATED APPLICATIONS

none

### BACKGROUND

1. Field of the Present Disclosure

This disclosure relates generally to protective covers and storage sleeves; and more particularly to a protective scratch resistant skin particularly suitable for protecting a laptop computer.

2. Description of Related Art

The following art defines the present state of this field and each U.S. documents is hereby incorporated herein by reference:

Harris, U.S. 2004/0217027, discloses a carrying case for a computer that is made of webbing to permit security personnel to view the computer without removing it from the case. The laptop can be opened and used without removing the case.

Hollingsworth, U.S. Pat. No. 5,607,054, discloses a carrying case for a notebook computer that includes front and back panels configured to cover opposite sides of the notebook computer, a top panel flexibly connecting top edges of the front and back panels, a bottom panel flexibly connected to a bottom edge of the back panel, a closure flap flexibly connected to a bottom edge of the bottom panel and overlapping a bottom edge of the front cover when the carrying case is in a closed position folded around the notebook computer, and a pair. of tabs depending from opposed lateral edges of the front panel toward the back panel when the carrying case is in a closed position. In the closed position, the carrying case serves as a folio to protectively cover the notebook computer and, in an open position, can also serve as a computer stand supporting the notebook computer in an ergonomic position.

Myles et al., U.S. Pat. No. 5,887,723, discloses a foldable jacket for a general purpose portable computer that includes a first protective panel having first and second sub-panels foldably connected along a first fold line. The first sub-panel has a fastener for fastening to the computer. A second protective panel is foldably connected to the first protective panel along a second fold line. A third protective panel is foldably connected to the second protective panel along a third fold line. A strap extending from the first sub-panel is capable of fastening to the third panel to secure the jacket substantially around the computer with the first and second sub-panels lying along the same plane. The jacket is also capable of being folded along the first and second fold lines such that the first and second sub-panels are at an angle relative to each other as well as the third panel. The first sub-panel is fastened to the third panel at an angle to tilt the computer for viewing and use.

Weill et al., U.S. Pat. No. 5,931,297, discloses a glove-like protective cover capable of encasing a notebook computer, thereby allowing it to be used in a hostile operating environment, such as outdoors or at a manufacturing site, without risk of debris and moisture reaching the computer and detrimentally affecting its performance. The protective cover includes a top pocket capable of having the screen section of the notebook computer inserted therein, and a bottom pocket capable of having the keyboard section of the computer inserted therein. In this way, the notebook computer can be placed in its open, operating position while encased in the protective cover. The portions of the cover overlying the screen and keyboard sections of the computer are transparent. Thus, an operator is able to see the screen and keyboard of the notebook computer through the protective cover. Further, the portion of the cover overlying the keyboard of the computer is flexible so as to allow the keyboard to be operated through the cover. The protective cover may also employ a shock absorbing apparatus capable of protecting the notebook computer from damage caused by impacts with other objects during transit or while in use.

Howard, Jr., U.S. Pat. No. 6,109,434, discloses an improved protective case for a portable, or laptop, computer. In particular, a protective case designed such that the computer may be kept therein during transport, storage, or use, is described. The protective case provides flexible hinge means to accommodate opening and closing the computer and case while the two remained attached to each other. The protective case contains means for protecting the computer from damage that may result from physical shock. The protective case provides for convenient access to all four sides of the portable computer, where necessary user interfaces, such as cable connectors, accessory ports and disk drives, are typically found, when the protective case is open, and protection therefor when the protective case is closed.

Akins, U.S. Pat. No. 6,149,001, discloses a cover for a portable computer made of a thin flexible material adapted to fit closely over the computer like a glove. The cover has cut-outs for the keyboard, screen, controls, ports, etc. of the computer so that the cover does not interfere with convenient use of the computer. The cover is compact and adds little additional volume or weight to the computer, while protecting the computer housing or case, providing an attractive appearance and also providing convenient accessories, such as pockets for a power supply cord, floppy disks, CD ROM disks, pencils, etc. The computer may be carried or used with the cover installed.

Seok, U.S. Pat. No. 6,267,236, discloses a protective case for protecting and covering a portable computer having an upper surface, a lower surface and a side surface that includes a first surface, a second surface, a connecting member and a plurality of elastic members. The first surface covers the upper surface of the portable computer, and the second surface covers the lower surface of the portable computer. The connecting member covers the side surface of the portable computer and connects the first surface and the second surface. The elastic members are inserted into the connecting member to enforce the connecting member to be attached to the portable computer.

Godshaw et al., U.S. Pat. No. 6,604,618, discloses an computer carrying case that is formed from a single set of connected panels that is foldable around personal computers or other items having a variety of sizes or dimensions including semi-rigid front and back panels connected by oversized, flexible or living hinges and connecting flyer.

Nykoluk et al., U.S. Pat. No. 6,691,843, discloses a compact case that can be manually carried or carried in another case, for example a brief case, is designed to protect fragile, delicate objects such as laptop computers contained in the case from side impacts of bumping or from dropping the case without appreciably detracting from the compact size of the computer carried in the case.

Our prior art search with abstracts described above teaches various laptop computer cases, containers, jackets and bags. Some of these items are relatively bulky and yet serve the purpose of physical protection provide convenience in carrying a laptop from place to place. Others of these prior art items serve further functions such as propping the laptop at an angle, or provide storage of small items such as those used on a desk. All of the prior art cases have in common that they provide a structural support function. In contrast, the present invention provides no structural function, but only a tough skin for preventing the laptop's surface from being scratched, marred or stained. Clearly, the prior art also provides this function, but at the cost of bulk, weight and cost. In contrast, the present invention adds no noticeable weight or bulk to a laptop computer and is relatively inexpensive to produce when compared with any one of the prior art cases.

### SUMMARY

This disclosure teaches certain benefits in construction and use which give rise to the objectives described below.

Laptop computers are configured to be as small and lightweight as possible. They also are designed to be rugged because they are subject to generally rough handling as they are carried from place to place. In this respect, such laptop computers may be scratched, marred and discolored, and this presents a problem to those wishing to maintain the appearance of their laptop. The prior art, as described above, provides a variety of solutions including carrying cases, protective covers, and jackets. However, all of the prior art solutions suffer at least one of the following problems: too heavy, too large, not form-fitting, or they must be removed in order to use the laptop; to open the laptop for instance. The present description defines a solution which overcomes these drawbacks and provides further advantages as will be shown.

The apparatus comprises a thin film skin jacket for a laptop computer. The skin is engaged with the computer placing a generally planar thin film top panel and a generally planar thin film bottom panel on the computers top and bottom exposed faces. The panels are joined by an elastic hinge around a rear panel. Corner grippers are engaged with the computer's corners to enable the jacket to fit tightly on the computer. The hinge is constructed so that with the corner grippers engaged with the computer, the hinge lays in a stretched condition around the rear panel with the computer open or closed thereby preventing bulging of the panels or hinge. The jacket therefore provides a second skin to the computer preventing scratches, mars and stains of the computer's outer surfaces and providing a small amount of cushioning to the computer as well. Such a skin enables the laptop computer to be placed in a duffle bag, or a back-pack, or a handbag with other items without being scratched or damaged. When ready to use the laptop computer, one need only place it on a surface, open it and start it. The jacket need not be removed and does not interfere with the computer's operation.

A primary objective inherent in the above described apparatus and method of use is to provide advantages not taught by the prior art.

Another objective is to provide a tight fitting laptop computer protective skin capable of preventing scratches and mars to the surface of the laptop computer without adding appreciable bulk or weight.

A further objective is to provide such a skin capable of permanent attachment to the laptop computer so that the skin need not be removed from the computer when in use.

A still further objective is to configure such a skin so that it does not prevent air flow cooling of the laptop computer.

A yet further objective is to configure the skin so that it does not bulge or wrinkle when the laptop is opened.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective view of one embodiment of the apparatus;

FIG. 2 is a perspective view of a second embodiment of the apparatus;

FIG. 3 is a perspective view of a third embodiment of the apparatus;

FIG. 4 is a perspective view of the apparatus as mounted on a laptop computer;

FIG. 5 is a rear elevational view thereof; and

FIG. 6 is a partial sectional view taken along line 6-6 in FIG. 4.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

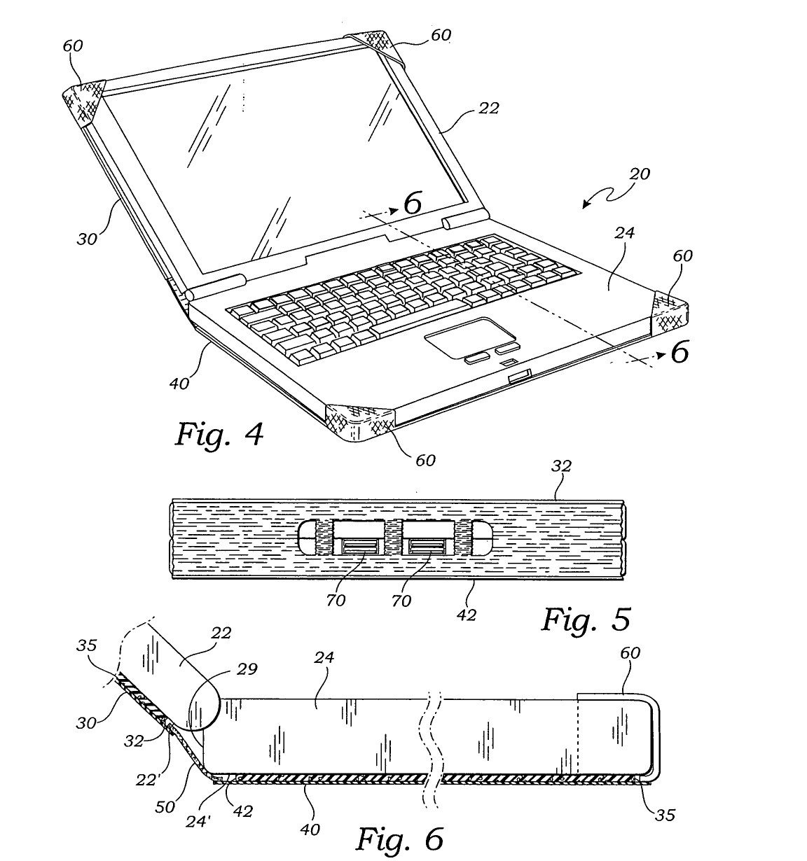

In the present description, a skin apparatus (skin) 10 is used to protect the exterior surfaces of a laptop computer 20. The skin 10 provides a thin film sheet top panel 30 and a thin film sheet bottom panel 40, the top panel 30 extensive for fully covering an exposed external surface 22′ of a top monitor portion 22 of the laptop computer (computer) 20, the bottom panel 40 extensive for fully covering an exposed external surface 24′ of a bottom portion 24 of the laptop computer 20. The top and bottom panels 30 and 40 respectively, are made of a thin film preferably polycarbonate, or similar tough engineering plastic sheet film having a thickness of between 0.003 and 0.035 inches. As such, these panels form a skin on the laptop computer 20 and are thus able to protect its surfaces. Film sheet below 0.003 inches have been found to be too fragile to be practical, and thicknesses above 0.035 inches have been found to be not cost effective for any minor added scratch resistance. However, a thicker film thickness may be used and such falls within the breath of the present claims. The top panel 30 is joined to the bottom panel 40 at mutually proximate edges 32 and 42 respectively, by an elastic hinge 50, preferably a thin film of rubber-like sheet or fabric. The panels 30, 40 each provide a pair of grippers 60 at corners of the skin 10 which are distal to the hinge 50. The grippers 60 are enabled for engagement of the skin 10 with distal corners of the computer 20, i.e., distal from the hinge 50. The elastic property of the hinge 50 is such that, with the grippers 60 engaged with the distal corners of the computer 20, the hinge 50 lays in a stretched condition proximate a rear panel 29 of the computer 20 when the top monitor portion 22 is in a closed attitude (FIG. 5), i.e., face-to-face with the bottom portion 24. Likewise, the hinge 50 is in a similar, although lesser, stretched condition when the top monitor portion 22 of the computer 20 is in an open attitude (FIGS. 4 and 6). Therefore, the hinge 50 does not buckle or bulge when the computer 20 is open for use as best seen in FIG. 6. This provides an advantage in that the panels 30, 40 are maintained in a tight fitting and flush state when the computer top monitor portion 22 is raised for use as a monitor.

Preferably, a soft spongy layer 35, such as a foam rubber is mounted between the exposed external surface 22′ of the top monitor portion 22 and the top panel 30, as well as between the exposed external surface 24′ of the bottom portion 24 and the bottom panel 40. This layer is preferably quite thin being preferably about 0.005 inches in thickness, yet able to absorb small shocks and bumps received by the computer 20.

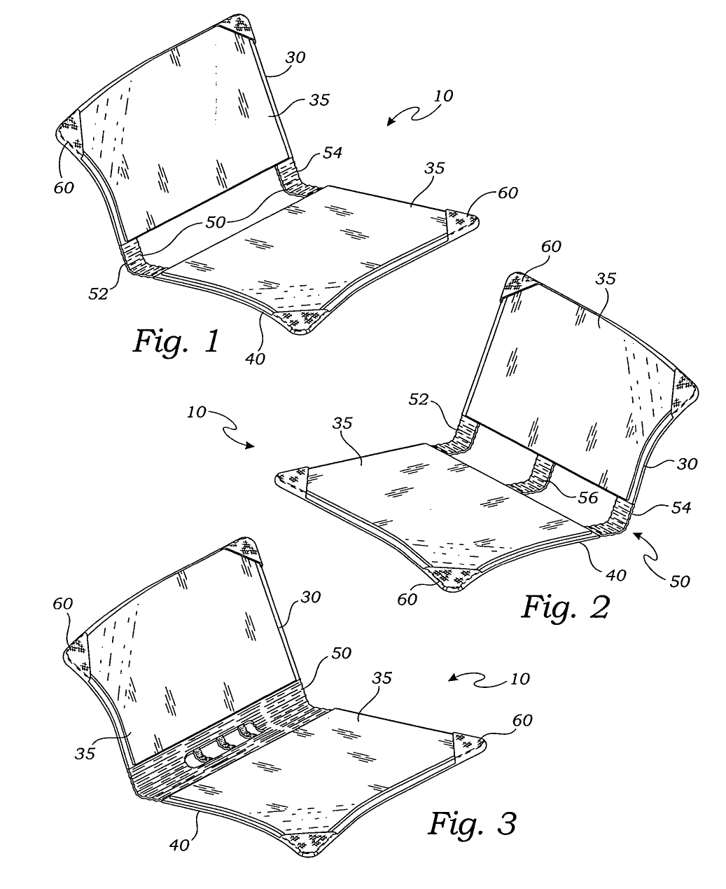

Preferably, the hinge 50 is positioned in non-overlapping juxtaposition to one or more exhaust ports 70 of the computer 20 when the skin 10 is mounted. This case is illustrated in FIG. 5. It is necessary that the skin 10 allow the computer 20 to exhaust cooling air flow without restriction. To accomplish this objective, the hinge 50 may be comprised of two hinge portions 52 and 54 in laterally spaced apart positions, as shown in FIG. 1 so as to avoid exhaust ports 70. The hinge 50 may also be comprised of one continuous strip as shown in FIG. 3, or more than two portions as shown in FIG. 2. In each case, the exhaust port 70 is not covered by the hinge 50. When two hinge portions 52 and 54 are used, they are preferably spaced maximally apart so as to assure that the panels 30 and 40 are fastened at their ends and not able to bend over without restraint. When three hinge portions 52, 54, 56 are used, the third hinge portion 56 is positioned between the portions 52 and 54 so as to assure that the medial portions of panels 30 and 40 do not bulge or wrinkle away from the computer 20. The preferred configuration of the hinge 50 is as shown in FIG. 3, as this enables the panels 30 and 40 to be fully constrained across the full width of the computer 20.

Preferably, the grippers 60 are pockets placed as shown and made of an elastic material capable of stretching over the distal corners of the computer 20 so that when the hinge 50 is stretched about the rear panel 29 of the computer 20, the panels 30 and 40 are tensioned to lay in conformance with the exterior surfaces 22′ and 24′ of the computer 20. The enablements described herein are considered novel over the prior art of record and are considered critical to the operation of at least one aspect of the apparatus and its method of use and to the achievement of the above objectives.

The computer 20 may be considered to be a part of the present invention as a combination apparatus in that the skin 10 and the computer 20 function synergistically, with the skin 10 providing exterior surface protection to the computer 20 and its surfaces, while the computer 20 provides the necessary rigid body to enable the skin 10 to be in tensioned tight fitting conformity to the exterior surfaces of computer 20.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A combination apparatus comprising: a laptop computer having a bottom portion enabled for computer operations and having an exhaust port in a rear panel of the bottom portion, and a top monitor portion, the top monitor portion hinged to the bottom portion for rotation between a closed attitude with the top and bottom portions aligned in face-to-face contact, and an open attitude wherein the top monitor portion is raised relative to the bottom portion; and a skin providing a generally planar top panel and a generally planar bottom panel, the top panel extensive for fully covering an exposed external surface of the top monitor portion, the bottom panel extensive for fully covering an exposed external surface of the bottom portion, the top panel joined to the bottom panel at mutually proximate edges thereof by an elastic hinge, the top and the bottom panels each providing a pair of comer grippers at comers of the skin distal to the hinge, the comer grippers enabled for engagement of the skin with comers of the top and bottom portions of the computer; the hinge having such elastic property, that, with the comer grippers engaged with the computer, the hinge lays in a stretched condition proximate the rear panel with the top monitor portion in the closed attitude and also in a stretched condition with the top monitor portion in the open attitude.

2. The apparatus of claim 1 further comprising a soft spongy layer between the exposed external surface of the top monitor portion and the top panel.

3. The apparatus of claim 1 further comprising a soft spongy layer between the exposed external surface of the bottom portion and the bottom panel.

4. The apparatus of claim 3 further comprising a soft spongy layer between the exposed external surface of the top monitor portion and the top panel.

5. The apparatus of claim 1 wherein the hinge is positioned in non-overlapping juxtaposition to the exhaust port.

6. The apparatus of claim 5 wherein the hinge is comprised of at least two hinge portions in laterally spaced apart positions.

7. The apparatus of claim 6 wherein the hinge portions comprise exactly two hinge portions positioned with maximal spacing therebetween.

8. The apparatus of claim 6 wherein the hinge portions comprise exactly three hinge portions with two of the three hinge portions positioned with maximal spacing therebetween and a third of the three hinge portions positioned between the two of the three hinge portions.

9. The apparatus of claim 1 wherein the corner grippers are of an elastic material capable of stretching over the distal corners of the top and bottom portions of the computer when the hinge portion is stretched about the rear panel of the computer.

11. The apparatus of claim 1 wherein the skin is of a scratch resistant film sheet of between 0.003 and 0.035 inches in thickness.

10. A protective outer covering apparatus for a laptop computer, the covering apparatus comprising: a skin providing a generally planar top panel and a generally planar bottom panel, the top panel extensive for fully covering an exposed external surface of a top monitor portion of the laptop computer, the bottom panel extensive for fully covering an exposed external surface of a bottom portion of the laptop computer, the top panel joined to the bottom panel at mutually proximate edges thereof by an elastic hinge, the top and the bottom panels each providing a pair of corner grippers at corners of the skin distal to the hinge, the corner grippers enabled for engagement of the skin with corners of the laptop computer; the hinge having such elastic property, that, with the corner grippers engaged with the computer, the hinge lays in a stretched condition proximate a rear panel of the computer when the top monitor portion is in a closed attitude, and also in a stretched condition with the top monitor portion is in an open attitude.

11. The apparatus of claim 10 further comprising a soft spongy layer between the exposed external surface of the top monitor portion and the top panel.

12. The apparatus of claim 10 further comprising a soft spongy layer between the exposed external surface of the bottom portion and the bottom panel.

13. The apparatus of claim 12 further comprising a soft spongy layer between the exposed external surface of the top monitor portion and the top panel.

14. The apparatus of claim 10 wherein the hinge is positioned in non-overlapping juxtaposition to an exhaust port of the computer when the skin is mounted thereon.

15. The apparatus of claim 14 wherein the hinge is comprised of at least two hinge portions in laterally spaced apart positions.

16. The apparatus of claim 15 wherein the hinge portions comprise exactly two hinge portions positioned with maximal spacing therebetween.

17. The apparatus of claim 15 wherein the hinge portions comprise exactly three hinge portions with two of the three hinge portions positioned with maximal spacing therebetween and a third of the three hinge portions positioned between the two of the three hinge portions.

18. The apparatus of claim 10 wherein the corner grippers are of an elastic material capable of stretching over the distal corners of the computer when the hinge portion is stretched about the rear panel of the computer.

19. The apparatus of claim 1 wherein the skin is of a scratch resistant film sheet of between 0.003 and 0.035 inches in thickness.

20. A protective outer covering apparatus for a laptop computer, the covering apparatus comprising: a skin of scratch resistant film sheet of between 0.003 and 0.035 inches in thickness, the skin providing a generally planar top panel and a generally planar bottom panel, the top panel extensive for fully covering an exposed external surface of a top monitor portion of the laptop computer, the bottom panel extensive for fully covering an exposed external surface of a bottom portion of the laptop computer, the top panel joined to the bottom panel at mutually proximate edges thereof by an elastic hinge, the top and the bottom panels each providing a pair of corner grippers at corners of the skin distal to the hinge, the corner grippers enabled for engagement of the skin with corners of the laptop computer; the hinge having such elastic property, that, with the corner grippers engaged with the computer, the hinge lays in a stretched condition proximate a rear panel of the computer when the top monitor portion is in a closed attitude, and also in a stretched condition with the top monitor portion is in an open attitude.
